(19) United States
(12) Patent Application Publication
(10) Pub. No.: US 2024/0291109 A1
(43) Pub. Date: Aug. 29, 2024

(54) SEPARATOR FOR NONAQUEOUS ELECTROLYTE SECONDARY BATTERY AND NONAQUEOUS ELECTROLYTE SECONDARY BATTERY

(71) Applicant: NITTO DENKO CORPORATION, Ibaraki-shi, Osaka (JP)

(72) Inventors: Kyotaro YAMADA, Ibaraki-shi, Osaka (JP); Yuki TAKEDA, Ibaraki-shi, Osaka (JP); Motoki HAISHI, Ibaraki-shi, Osaka (JP); Kenji FURUTA, Ibaraki-shi, Osaka (JP)

(21) Appl. No.: 18/573,492

(22) PCT Filed: Jun. 27, 2022
(86) PCT No.: PCT/JP2022/025598

§ 371 Date: Dec. 22, 2023

(30) Foreign Application Priority Data
Jun. 28, 2021 (JP) 2021-106550

(51) Int. Cl. H01M 50/457; H01M 50/434

(52) U.S. Cl. CPC H01M 50/457; H01M 50/434

(57) ABSTRACT

A separator for a nonaqueous electrolyte secondary battery according to the present invention includes a porous base material, a metal layer situated over either or both of opposite surfaces of the porous base material, and a metal oxide layer situated either over one of opposite surfaces of the metal layer or over both of the opposite surfaces of the metal layer, the one being a surface opposite to a surface of the metal layer on a side of the porous base material.

### TECHNICAL FIELD

The present invention relates to a separator for a nonaqueous electrolyte secondary battery and a nonaqueous electrolyte secondary battery.

### BACKGROUND ART

Nonaqueous electrolyte secondary batteries such as lithium ion secondary batteries are widely used as power sources of portable electronic devices such as portable terminals, portable phones, and laptop personal computers, and of electric-powered vehicles such as electric cars. In a nonaqueous electrolyte secondary battery, a separator made of a polymeric porous membrane is typically situated between a positive electrode and a negative electrode.

The separator is impregnated with an electrolytic solution to secure conductivity across the pair of electrodes, and also separates the electrodes from each other to inhibit short-circuiting across the electrodes. The separator also has a shutdown function of the separator itself melting to become free of pores when the interior of the battery has reached a high temperature due to some abnormality. The shutdown function, which gets the conductivity lost from inside the battery, ensures safety of the nonaqueous electrolyte secondary battery.

As nonaqueous electrolyte secondary batteries become popular, various methods are studied in order to further increase the safety of the nonaqueous electrolyte secondary batteries. In a lithium ion secondary battery disclosed as such a method and including a positive electrode, a negative electrode, and a separator situated between the positive electrode and the negative electrode, for example, the separator includes a resin layer and a porous metal layer imparted to a surface of the resin layer facing the negative electrode (for example, see Patent Document 1). The separator of Patent Document 1 secures a conductive state between the separator and the negative electrode by having a porous metal layer thickness of 1 μm or less, so that a charging-discharging cyclicity can be exhibited.

### CITATION LIST

### Patent Document

[Patent Document 1] Japanese Unexamined Patent Application Publication No. 2011-222215

### SUMMARY OF INVENTION

### Problem to be Solved by Invention

However, Patent Document 1 does not study durability of the lithium ion secondary battery. Patent Document 1 has a problem that as the porous metal layer formed over the surface of the resin layer undergoes natural oxidization and the natural oxidization develops from the surface to the interior of the porous metal layer until ultimately the entirety of the porous metal layer has undergone natural oxidization, the function of the porous metal layer is lost and the durability of the separator is reduced. Reduction in the durability of the separator reduces the charging-discharging performance of the lithium ion secondary battery and shortens the lifetime of the lithium ion secondary battery.

According to an embodiment of the present invention, it is an object to provide a separator for a nonaqueous electrolyte secondary battery, the separator being able to exert excellent durability when applied to a nonaqueous electrolyte secondary battery.

### Means for Solving Problem

An embodiment of a separator for a nonaqueous electrolyte secondary battery according to the present invention includes a porous base material, a metal layer situated over either or both of opposite surfaces of the porous base material, and a metal oxide layer situated either over one of opposite surfaces of the metal layer or over both of the opposite surfaces of the metal layer, the one being a surface opposite to a surface of the metal layer on a side of the porous base material.

### Advantageous Effects of Invention

An embodiment of a separator for a nonaqueous electrolyte secondary battery according to the present invention can exert excellent durability when applied to a nonaqueous electrolyte secondary battery.

### BRIEF DESCRIPTION OF DRAWINGS

FIG. 1 is a schematic cross-sectional view illustrating an example of a configuration of a separator for a nonaqueous electrolyte secondary battery according to an embodiment of the present invention.

FIG. 2 is a schematic cross-sectional view illustrating another example of the configuration of the separator for a nonaqueous electrolyte secondary battery.

FIG. 3 is a graph indicating the results of XRD measurement in Example 3 and Comparative Example 1.

### DESCRIPTION OF EMBODIMENTS

Embodiments of the present invention will be described in detail below. For facilitating understanding of the description, the same components in the drawings will be denoted by the same reference numerals, and overlapping descriptions of the same components will be omitted. The components in the drawings may not be to scale. In the present specification, the term “through” indicating numerical ranges mean to include the values specified before and after the term “through” as the lower limit value and the upper limit value, unless otherwise specified.

### <Separator for a Nonaqueous Electrolyte Secondary Battery>

A separator for a nonaqueous electrolyte secondary battery (hereinafter, simply referred to as “secondary battery separator”) according to an embodiment of the present invention will be described.

The secondary battery separator according to the present embodiment includes a porous base material, a metal layer situated over either or both of opposite surfaces of the porous base material, and a metal oxide layer situated either over one of opposite surfaces of the metal layer or over both of the opposite surfaces of the metal layer, the one being a surface opposite to a surface of the metal layer on the side of the porous base material.

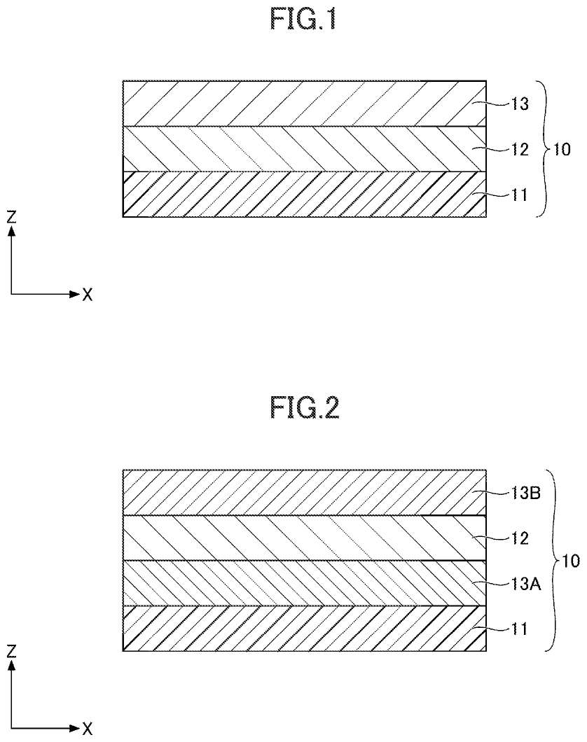

FIG. 1 is a schematic cross-sectional view illustrating an example of the configuration of the separator for a nonaqueous electrolyte secondary battery according to the present embodiment. As illustrated in FIG. 1, a secondary battery separator 10 according to the present embodiment includes a porous base material 11, a metal layer 12, and a metal oxide layer 13, and includes the metal layer 12 and the metal oxide layer 13, which are laminated in this order over the upper surface of the porous base material 11. The secondary battery separator 10 may include a metal layer 12 and a metal oxide layer 13 that are laminated in this order over the lower surface of the porous base material 11.

In the present specification, the direction of the thickness (perpendicular direction) of the secondary battery separator 10 is described as a Z-axis direction, and a lateral direction (horizontal direction) orthogonal to the direction of the thickness is described as an X-axis direction. The metal oxide layer 13 side in the Z-axis direction is described as a +Z-axis direction, and the porous base material 11 side in the Z-axis direction is described as a −Z-axis direction. In the following description, for expediency of description, the +Z-axis direction is described as upper or upper side, and the −Z-axis direction is described as lower or lower side. However, these terms do not represent the universal relationship regarding the height.

### [Porous Base Material]

The porous base material 11 is a porous membrane (porous film), and is formed in a plate shape (film shape). The porous base material 121 includes a base material main body, and an adhesive porous layer or adhesive porous layers formed over one surface (principal surface) of, or both of opposite surfaces (opposite principal surfaces) of the base material main body.

### (Base Material Main Body)

The base material main body contains vacancies and voids in the interior. Examples of the base material main body include: a porous membrane; a porous sheet made of a fibrous material, such as a nonwoven cloth and paper; and a complex porous sheet including a porous membrane or a porous sheet and another or more porous layers laminated over the porous membrane or the porous sheet. In the present embodiment, a porous membrane is preferable in order to make the porous base material 11 thin and in terms of the strength of the porous base material 11. A porous membrane is a membrane having a structure including multiple pores in the interior, the pores being mutually linked so that a gas or a liquid can pass from one surface to an opposite surface of the membrane.

As the material of the base material main body, a material having an electrical insulating property is preferable. Organic materials and inorganic materials are both acceptable.

It is preferable that the base material main body contains a thermoplastic resin, because a thermoplastic resin has a shutdown function. The shutdown function is a function of shutting off migration of ions across electrodes by the constituent material of the base material main body dissolving and blocking the pores in the base material main body when the battery temperature has risen, to inhibit thermal runaway of the battery.

As the thermoplastic resin, a thermoplastic resin having a melting point lower than 200° C. is preferable. Examples of the thermoplastic resin include: polyolefins such as polyethylene (PE), polypropylene (PP), polybutylene (PB), and polypentene; and polyesters such as polyethylene terephthalate (PET). These thermoplastic resins may be used alone or in combination of two or more. Among these thermoplastic resins, polyolefins are preferable, polyethylene is more preferable in terms of the shutdown function, and it is yet more preferable that polyethylene and polypropylene are contained because they have the shutdown function and a heat resistance that does not easily let the membrane be torn when exposed to a high temperature. Polyethylene and polypropylene may coexist in one layer. In this case, for example, the content of polyethylene may be 95% by mass or greater and the content of polypropylene may be 5% by mass or less.

As the porous membrane, it is preferable to use a porous membrane containing a polyolefin (referred to as a polyolefin porous membrane). Any polyolefin porous membrane may be appropriately selected, and it is preferable to select one that has a sufficient ion permeability.

It is preferable that the polyolefin porous membrane contains polyethylene, because polyethylene exhibits the shutdown function. The content of polyethylene is preferably 95% by mass or greater relative to the mass of the entire polyolefin porous membrane.

It is preferable that the polyolefin porous membrane contains polypropylene, because polypropylene has a heat resistance that does not easily let the membrane be torn when exposed to a high temperature.

In terms of satisfying both of the shutdown function and heat resistance, the polyolefin porous membrane may include a layer containing polyethylene and a layer containing polypropylene, and may have a two or more-layered multilayered structure in which these layers are laminated.

The weight average molecular weight (Mw) of polyolefin to be contained in the polyolefin porous membrane is preferably, for example, from 100,000 through 5,000,000 in order for the membrane to have a sufficient mechanical property and a good shutdown property, and in terms of ease of molding.

An example of the method for producing the porous membrane will be described. Examples of the method include: a method of extruding a melted thermoplastic resin from a T-die into a sheet shape, crystallizing and stretching the obtained sheet, and subsequently thermally treating the resulting product, to produce a porous membrane; and a method of extruding a thermoplastic resin that is melted together with a plasticizer such as liquid paraffin from a T-die, cooling the resulting product, stretching the obtained gel-like sheet, washing the resulting product in a methylene chloride bath to extract the plasticizer, and subsequently thermally treating and drying the washed sheet, to produce a porous membrane.

As the porous sheet, it is preferable to use: polyolefins such as polyethylene (PE) and polypropylene (PP); heat-resistant resins such as wholly aromatic polyamide, polyamide imide (PAI), polyimide (PI), polyether sulfone (PES), polysulfone (PSU), polyether ketone (PEK), and polyether imide (PEI); and fibrous materials such as cellulose.

Examples of the complex porous sheet include a complex sheet obtained by laminating a functional layer over a porous membrane or a porous sheet. The complex porous sheet is preferable because the functional layer can add an additional function.

In terms of imparting heat resistance, examples of the functional layer include: a porous layer made of a heat-resistant resin; and a porous layer made of a heat-resistant resin and an inorganic filler.

Examples of the heat-resistant resin include wholly aromatic polyamide (wholly aromatic PA), polyamide imide (PAI), polyimide (PI), polyether sulfone (PES), polysulfone (PAI), polyether ketone (PEK), and polyether imide (PEI). These heat-resistant resins may be used alone or in combination or two or more.

Examples of the inorganic filler include: metal oxides such as alumina; and metal hydroxides such as magnesium hydroxide.

Examples of the complex producing method include a method of applying a functional layer over a porous membrane or a porous sheet by coating, a method of bonding a porous membrane or a porous sheet and a functional layer with each other with an adhesive, and a method of bonding a porous membrane or a porous sheet and a functional layer with each other by thermal compression bonding.

In order to have an improved wettability with a coating liquid for forming the adhesive porous layer, the surface of the base material main body may optionally be subjected to various surface treatments such as a corona treatment, a plasma treatment, a flame treatment, and an ultraviolet irradiation treatment to an extent that the base material main body does not lose its property.

The thickness of the base material main body may be appropriately selected, and is preferably from 3 μm through 25 μm, more preferably from 5 μm through 20 μm, and yet more preferably from 7 μm through 15 μm in order to increase the energy density of a nonaqueous electrolyte secondary battery when the secondary battery separator 10 is applied to the nonaqueous electrolyte secondary battery, and in terms of the production yields of the secondary battery separator 10 and of nonaqueous electrolyte secondary batteries when the secondary battery separator 10 is applied to nonaqueous electrolyte secondary batteries.

In the present specification, the thickness of the base material main body is a length of the base material main body in a direction perpendicular to the principal surfaces of the base material main body. The thickness of the base material main body may be, for example, a thickness measured at a desirably selected location in a cross-section of the base material main body, or may be an average of measurements obtained at more than one desirably selected locations. In the following description, the thickness will be defined the same for any other members.

The Gurley value (Japanese Industrial Standards (JIS) P8117: 2009) of the base material main body is preferably from 50 seconds/100 mL through 300 seconds/100 mL in terms of ion permeability or mitigation of short-circuiting in a nonaqueous electrolyte secondary battery when the secondary battery separator 10 is applied to the nonaqueous electrolyte secondary battery.

The voidage of the base material main body is preferably from 20% through 80%, more preferably from 25% through 65%, and yet more preferably from 30% through 55%. When the voidage of the base material main body is in the preferable range specified above, the secondary battery separator 10 has a good air permeance, can flow a high current by inhibiting increase in electrical resistance due to the base material main body, and can also have a sufficient mechanical strength. The voidage is a percentage (% by volume) at which void portions occupy the base material main body.

The puncture strength of the base material main body is preferably 300 g or greater in terms of the production yield of the secondary battery separator 10 and the production yield of nonaqueous electrolyte secondary batteries when the secondary battery separator 10 is applied to nonaqueous electrolyte secondary batteries. The puncture strength of the base material main body is, for example, the maximum puncture load (unit: g) measured in a puncture test performed using a compression tester under conditions including a needle tip curvature radius of 0.5 mm and a puncture rate of 2 mm/second.

### (Adhesive Porous Layer)

The adhesive porous layer is a layer formed over at least one surface of the base material main body, and may be formed over only one surface of, or both of opposite surfaces of the base material main body. The adhesive porous layer may have a function for increasing the strength of the secondary battery separator 10, may have a function for binding the base material main body with an electrode, or may have both of these functions at the same time. The adhesive porous layer is a layer to be bonded with an electrode when applying the secondary battery separator 10 to a nonaqueous electrolyte secondary battery and overlaying the secondary battery separator 10 and the electrode over each other. The adhesive porous layer has a structure including multiple pores in the interior, the pores being mutually linked so that a gas or a liquid can pass from one surface to an opposite surface of the layer.

The adhesive porous layer may be provided over only one surface of the porous base material or over both of opposite surfaces of the porous base material. When adhesive porous layers are provided over both of opposite surfaces of the porous base material, the secondary battery separator 10 can bond with both poles of a nonaqueous electrolyte secondary battery favorably, when the secondary battery separator 10 is applied to the nonaqueous electrolyte secondary battery. Moreover, the secondary battery separator 10 does not readily curl, and can be handled well during production of a nonaqueous electrolyte secondary battery. When an adhesive porous layer is provided over only one surface of the base material main body, the secondary battery separator 10 has a better ion permeability. Moreover, the thickness of the entire secondary battery separator 10 can be reduced, and it is possible to produce a nonaqueous electrolyte secondary battery having a higher energy density.

As the material for forming the adhesive porous layer, an adhesive resin can be used. Examples of the adhesive resin include polyvinylidene fluoride (PVDF), vinylidene fluoride/hexafluoropropylene copolymers, vinylidene fluoride/trichloroethylene copolymers, polyimide, polymethyl methacrylate, polybutyl acrylate, polyacrylonitrile, polyvinyl pyrrolidone, polyvinyl acetate, ethylene/vinyl acetate copolymers, polyethylene oxide, polyamide imide, polyimide, polyarylate, cellulose acetate, cellulose acetate butyrate, cellulose acetate propionate, cyanoethyl pullulan, cyanoethyl polyvinyl alcohol, cyanoethyl cellulose, cyanoethyl sucrose, pullulan, and carboxymethyl cellulose. Among these adhesive resins, either or both of fluorine atom-containing resins and acrylic resins are preferable, and polyvinylidene fluoride (PVDF) is particularly preferable. These resins may be used alone or in combination of two or more.

The amount of a vinylidene fluoride copolymer in the adhesive porous layer is preferably from 10% by mass through 100% by mass. When the amount of a vinylidene fluoride copolymer is in the range specified above, the resin layer and the base material main body tend to have an increased adhesiveness, the resin layer and an electrode tend to have an increased adhesiveness, the secondary battery separator 10 tends to have an increased strength, and the resin layer itself tends to have an increased strength. The thickness of the resin layer is appropriately selected in accordance with the function of the resin layer and is not particularly limited.

The adhesive porous layer may contain a filler in addition to the adhesive resin. As the filler, either or both of inorganic particles and organic particles are more preferable. The inorganic particles are not particularly limited, and examples of the inorganic particles include calcium carbonate, calcium phosphate, amorphous silica, crystalline glass fillers, kaolin, talc, titanium dioxide, alumina, boehmite, silica-alumina complex oxide particles, barium sulfate, calcium fluoride, lithium fluoride, zeolite, molybdenum sulfide, and mica. Examples of the organic particles include heat-resistant cross-linked polymer particles. Examples of the heat-resistant cross-linked polymer particles include cross-linked polystyrene particles, cross-linked acrylic particles, and cross-linked methyl methacrylate particles. Examples of the shape of the inorganic particles and the organic particles include a true spherical shape, an approximately spherical shape, a plate shape, an acicular shape, and a polyhedral shape. The shape of the inorganic particles and the organic particles is not particularly limited.

By containing a filler, the adhesive porous layer can inhibit internal short-circuiting due to growth of a dendritic crystal (dendrite) from an electrode, when the secondary battery separator 10 is applied to a nonaqueous electrolyte secondary battery. Hence, it is possible to inhibit thermal runaway that is due to internal short-circuiting in the nonaqueous electrolyte secondary battery, and that may shrink the porous base material (particularly, a polyolefin porous membrane). These fillers may be used alone or in combination of two or more. The content of the filler in the adhesive porous layer is preferably from 10% by volume through 99% by volume, more preferably from 20% by volume through 90% by volume, and yet more preferably from 30% by volume through 80% by volume. When the content of the filler in the adhesive porous layer is in the preferable range specified above, it is possible to effectively inhibit occurrence of a dendrite, or to inhibit thermal runaway that may shrink a polyolefin porous base material.

The method for forming the adhesive porous layer is not particularly limited. For example, it is possible to use a method of applying a coating liquid containing the adhesive resin and a solvent (dispersion medium) over a surface of the base material main body, and drying the solvent, to form the adhesive porous layer. For example, the coating liquid is prepared by dissolving or dispersing the adhesive resin in the solvent. Examples of the method for applying the coating liquid over a surface of the base material main body include common publicly-known coating methods. As such a coating method, for example, a dip coating method, a wire bar method, a gravure coating method, a kiss method, a die coating method, a roll coating method, and a comma coating method can be used.

When the coating liquid is applied over one or both of opposite surfaces of the base material main body (porous film) and the base material main body is subsequently immersed in a water-based solvent, the applied resin solidifies in a three-dimensional network-like shape. In this way, the adhesive porous layer is formed. The water-based solvent is a solvent containing water, which is a poor solvent for the resin. Examples of the solvent that can coexist with water include alcohols, acetone, and N-methyl-2-pyrrolidone. After being formed over a surface of the base material main body, the adhesive porous layer is dried in a heating furnace. The drying temperature in the heating furnace is preferably in a range of from 40° C. through 100° C. The time in the heating furnace is appropriately adjusted in accordance with the temperature in the heating furnace, yet is preferably in a range of from 40 seconds through 120 seconds. The film tension during conveying is preferably in a range of from 3 MPa through 10 MPa.

When drying the adhesive porous layer, it is preferable that the adhesive porous layer is dried to an extent that at least part of the solvent (dispersion medium) in the adhesive porous layer can be removed. Drying may be performed a plurality of times at different temperatures, and pressure may be applied during drying. Drying may further be followed by thermal treatment For example, the drying temperature is preferably from 40° C. through 150° C. and more preferably from 45° C. through 130° C., and the drying time may be from 1 minute through 15 hours.

The thickness of the adhesive porous layer is preferably from 0.05 μm through 3 μm, and more preferably from 0.1 μm through 2.5 μm. When the thickness of the adhesive porous layer is in the preferable range specified above, the film resistance of the secondary battery separator 10 can be inhibited to a low level, and the secondary battery separator 10 can have a good adhesiveness with an electrode and can maintain a mechanical strength when applied to a nonaqueous electrolyte secondary battery.

### [Metal Layer]

As illustrated in FIG. 1, the metal layer 12 is situated over one surface (principal surface) of the porous base material 11. The metal layer 12 may be situated over both of opposite surfaces (both of opposite principal surfaces) of the porous base material 11.

As the material for forming the metal layer 12, for example, Cu, C, Sn, Al, Si, Bi, Ag, and Au may be used. Among these materials, Cu is preferable because it is low-cost and can be easily handled. These materials may be used alone or in combination of two or more. When using two or more materials in combination, an inorganic material layer 122 may contain two or more materials in a mixed state obtained by a multi-sputtering method, or two or more inorganic material layers 122 containing different materials may be laminated by a single sputtering method.

The thickness of the metal layer 12 may be appropriately set, and is preferably, for example, from 5 nm through 100 nm, more preferably from 8 nm through 50 nm, and yet more preferably from 10 nm through 30 nm. When the thickness of the metal layer 12 is in the preferable range specified above, a desired air permeance can be obtained, and it is possible to inhibit: increase in the mass of the secondary battery separator 10; and reduction in the handleability of the secondary battery separator 10.

### [Metal Oxide Layer]

As illustrated in FIG. 1, the metal oxide layer 13 is situated over a surface (principal surface) of the metal layer 12 opposite to a surface of the metal layer 12 on the side of the porous base material 11. When metal layers 12 are situated over both of opposite surfaces of the porous base material 11, metal oxide layers 13 may be situated over surfaces of the respective metal layers 12 opposite to surfaces of the respective metal layers 12 on the porous base material 11 side.

As the material for forming the metal oxide layer 13, for example, oxides and oxynitrides containing, for example, Cu, C, Sn, Al, Si, Bi, Ag, and Au may be used. Among these materials, Cu is preferable because it is low-cost and can be easily handled. These materials may be used alone or in combination of two or more. When using two or more materials in combination, an inorganic material layer 122 may contain two or more materials in a mixed state obtained by a multi-sputtering method, or two or more inorganic material layers 122 containing different materials may be laminated by a single sputtering method.

The type of the metal contained in the metal layer 12 and the metal oxide layer 13 may be the same or different.

The thickness of the metal oxide layer 13 is from 3 nm through 100 nm, preferably from 5 nm through 50 nm, and yet more preferably from 10 nm through 30 nm. When the thickness of the metal oxide layer 13 is less than 3 nm, the metal oxide layer 13 highly probably may not sufficiently function as a protection layer for the metal layer 12, and the metal oxide layer 13 may not be formed with a uniform thickness. On the other hand, when the thickness of the metal oxide layer 13 is greater than 100 nm, the metal oxide layer 13 does not have any greater performance as a protection layer for the metal layer 12 by having such an extra thickness. Moreover, the air permeance of the secondary battery separator 10 may be reduced, and the mass of the secondary battery separator 10 may increase and the handleability of the secondary battery separator 10 may be reduced. Furthermore, the surface or the interior of the metal oxide layer 13 may be cracked, and the performance of the metal oxide layer 13 may be reduced.

It is possible to determine whether an oxide is present or absent as the metal oxide layer 13, based on a peak area of a metal oxide that may be observed by X-ray diffractometry (XRD). As an indicator of the presence or absence of a metal oxide, a ratio (peak area ratio ((S1+S2A)/S2B)) of the sum of a peak area S1 of a diffraction peak attributable to a metal oxide that is contained in the metal oxide layer 13 and a first peak area S2A of a first diffraction peak attributable to the metal contained in the metal layer 12 to a second peak area S2B of a second diffraction peak attributable to the metal contained in the metal layer 12 is preferably 1.40 or greater, more preferably 2.00 or greater, and yet more preferably 2.50 or greater. When the peak area ratio S1/S2 is 1.40 or greater, it can be confirmed that the metal oxide layer 13 is formed over a surface of the metal layer 12. In this case, it can be confirmed that the metal oxide layer 13 functions as a protection layer for the metal layer 12 and can protect the entirety of the surface of the metal layer 12. The metal oxide layer 13 may be made only of an oxide, or may contain a natural oxide membrane that occurs by natural oxidization of part of a surface of the metal layer 12.

When there is one diffraction peak attributable to the metal contained in the metal layer, the diffraction peak may be regarded as the second diffraction peak, and it may be regarded that there is no first diffraction peak. In this case, the peak area ratio can be expressed as S1/S2B.

When the metal oxide layer 13 is CuO and the metal layer 12 is Cu, the peak area ratio S1 is a peak area (CuO(006)) of a diffraction peak that is attributable to a CuO plane defined by Miller indices (006) and that centers at 42.7°. The two peak areas of Cu include a first peak area S2A (Cu(111)) of a first diffraction peak that is attributable to a Cu plane defined by Miller indices (111) and that centers at 43.3°, and a second peak area (Cu(200)) of a second diffraction peak that is attributable to a Cu plane defined by Miller indices (200) and that centers at 50.4°. Here, the peak area ratio S1/S2, or the peak area ratio ((S1+S2A)/S2B)) is expressed as ((CuO(006)+Cu(111))/Cu(200).

An example of the method for producing the secondary battery separator 10 will be described.

First, the metal layer 12 is formed over an upper surface of the porous base material 11, which is one surface thereof. The method for forming the metal layer 12 may be, for example, a dry process. The dry process may be, for example, sputtering or vacuum vapor deposition. As the method for forming the metal layer 12, a dry process is preferable in terms of forming the metal layer 12 to be thin, and sputtering is more preferable in terms of making the density of the metal layer 12 high.

When employing sputtering, for example, it is possible to form the metal layer 12 by sputtering a metal onto the upper surface of the porous base material 11, which is one surface thereof, by a sputtering method, from a target containing the metal, which is Cu, C, Sn, Al, Si, Bi, Ag, or Au in an Ar gas atmosphere.

Next, the metal oxide layer 13 is formed by sputtering a metal onto the metal layer 12, i.e., onto an upper surface thereof that is opposite to its porous base material 11 side, by a sputtering method, from a target containing Cu, C, Sn, Al, Si, Bi, Ag, or Au in a mixed gas atmosphere containing Ar and oxygen. In this way, the secondary battery separator 10 is obtained.

The metal oxide layer 13 may be formed over the metal layer 12 by performing sputtering in the same manner as described above, from a target containing an oxide of Cu, C, Sn, Al, Si, Bi, Ag, or Au in a gas atmosphere changed to an Ar gas atmosphere.

During formation of the metal layer 12 and the metal oxide layer 13, for example, the flow rate ratio between Ar and oxygen, and the pressure in the mixed gas atmosphere when performing sputtering may be appropriately set.

When employing a dry process such as sputtering and vacuum vapor deposition for forming the metal layer 12 and the metal oxide layer 13, it is preferable to cool a table on which the porous base material 11 is set to, for example 0° C. or lower. When forming the metal layer 12 and the metal oxide layer 13 by employing, for example, sputtering or and vacuum vapor deposition, the porous base material 11 may be damaged because a high-temperature thermal load is applied to the porous base material 11 when the metal layer 12 and the metal oxide layer 13 are formed thereover. Hence, when forming the metal layer 12 and the metal oxide layer 13 by employing, for example, sputtering and vacuum vapor deposition, cooling the porous base material 11 by cooling the table on which the porous base material 11 is set makes it possible to form the metal layer 12 and the metal oxide layer 13 while maintaining the durability of the porous base material 11.

In a case of forming metal layers 12 and metal oxide layers 13 over both of opposite surfaces of the porous base material 11, after a metal layer 12 is formed over one surface (upper surface) of the porous base material 11, the other surface (the lower surface in FIG. 1) of the porous base material 11 is turned upward and a metal is sputtered onto the other surface (the lower surface in FIG. 1) of the porous base material 11 in the same manner as described above to form a metal layer 12. Subsequently, in the same manner as described above, a metal oxide is sputtered onto a surface (the lower surface in FIG. 1) of the metal layer opposite to the metal layer's porous base material 11 side, to form a metal oxide layer 13. In this way, the secondary battery separator 10 can include metal layers 12 and metal oxide layers 13, which are laminated in this order, over both of the upper and lower surfaces of the porous base material 11.

Hence, the secondary battery separator 10 includes the metal layer 12 and the metal oxide layer 13, which are laminated in this order, over the porous base material 11. Because at least the upper surface of the metal layer 12 is coated with the metal oxide layer 13, the upper surface of the metal layer 12 can be inhibited from being oxidized. Hence, even when the secondary battery separator 10 is exposed to a high-temperature, or high-humidity, or high-temperature and high-humidity environment by being applied to a nonaqueous electrolyte secondary battery, it can keep the metal layer 12 functioning and have an improved durability, because the metal layer 12 can be inhibited from development of oxidization from the upper surface to the interior thereof. Hence, the secondary battery separator 10 can have excellent durability when applied to a nonaqueous electrolyte secondary battery.

In general, a metal thin film having a thickness of from some nanometers through some micrometers may become an oxide and lose the property of the metal thin film by undergoing gradual oxidization from at least one of the surface at the external side and the surface at the porous base material side to the interior. In the secondary battery separator 10 according to the present embodiment, the metal oxide layer 13 that is proactively provided over the metal layer 12 can inhibit development of oxidization from the upper surface of the metal layer 12 to the interior thereof because the metal oxide layer 13 functions as a passive state layer and serves as a protection layer for the metal layer 12. Hence, even when the secondary battery separator 10 is exposed to a high-temperature or high-humidity environment by being applied to a nonaqueous electrolyte secondary battery, it can be inhibited from oxidization of the metal layer 12 and can have a high durability, making it possible to maintain, for example, the charging-discharging performance of the nonaqueous electrolyte secondary battery.

In the present embodiment, a high-temperature environment is an environment in which the temperature is from 40° C. through 100° C. A high-humidity environment is an environment in which the humidity is 80% or higher. A high-temperature and high-humidity environment is an environment in which the temperature is from 40° C. through 100° C. and the humidity is 80% or higher, and is, for example, an environment in which the temperature is 60° C. and the humidity is 90%, and an environment in which the temperature is 85° C. and the humidity is 85%.

It is possible to evaluate the durability based on a resistance changing percentage that can be obtained by measuring the resistance of the metal layer 12. The resistance of the metal layer 12 can be measured using, for example, a non-contact resistance measuring instrument according to an eddy current measuring method based on JIS Z 2316-1: 2014. For example, it is possible to obtain the resistance changing percentage by measuring the resistances of the secondary battery separator 10 before and after being placed in a high-humidity environment, a high-temperature environment, or a high-temperature and high-humidity environment, and dividing the difference between the resistance values of the secondary battery separator 10 before and after being placed in a high-humidity environment, a high-temperature environment, or a high-temperature and high-humidity environment by the resistance value of the secondary battery separator 10 before being placed in a high-humidity environment, a high-temperature environment, or a high-temperature and high-humidity environment and multiplying the result by 100 as the formula (1) below.

Resistance changing percentage=((Resistance value of secondary battery separator 10 after being placed in a high-humidity environment, a high-temperature environment, or a high-temperature and high-humidity environment)−(Resistance value of secondary battery separator 10 before being placed in a high-humidity environment, a high-temperature environment, or a high-temperature and high-humidity environment))/(Resistance value of secondary battery separator 10 before being placed in a high-humidity environment, a high-temperature environment, or a high-temperature and high-humidity environment)×100(%) (1)

In a high-humidity environment, the durability of the secondary battery separator 10 in the high-humidity environment can be evaluated as being good, when the resistance changing percentage is less than or equal to a predetermined value (e.g., 20%). The predetermined value for the high-humidity environment is more preferably 15% and yet more preferably 10%.

In a high-temperature environment, the durability of the secondary battery separator 10 in the high-temperature environment can be evaluated as being good, when the resistance changing percentage is less than or equal to a predetermined value (e.g., 1,000%). The predetermined value for the high-temperature environment is more preferably 500% and yet more preferably 400%.

In a high-temperature and high-humidity environment, the durability of the secondary battery separator 10 in the high-temperature and high-humidity environment can be evaluated as being good, when the resistance changing percentage is less than or equal to a predetermined value (e.g., 100%). The predetermined value for the high-temperature and high-humidity environment is more preferably 80% and yet more preferably 60%.

In the secondary battery separator 10, the thickness of the metal oxide layer 13 can be from 3 nm through 100 nm. Hence, the metal oxide layer 13 can sufficiently function as a protection layer for the metal layer 12, and it is possible to inhibit occurrence of cracks in the surface or the interior of the metal oxide layer 13. Hence, the function of the metal oxide layer 13 as the protection layer for the metal layer 12 can be inhibited from being reduced, and the surface of the metal layer 12 can be reliably coated with and protected by the metal oxide layer 13. Hence, the secondary battery separator 10, which ensures a sustained durability of the metal layer 12, can more reliably sustain its durability when applied to a nonaqueous electrolyte secondary battery. Moreover, it is possible to inhibit reduction in the air permeance of the secondary battery separator 10, and to make the secondary battery separator 10 easy to handle by saving the weight of the secondary battery separator 10.

It is possible to provide the secondary battery separator 10 with a peak area ratio ((S1+S2A)/S2B)) of 1.40 or greater, the peak area ratio being a ratio of the sum of an area S1 of a peak attributable to the metal oxide contained in the metal oxide layer 13 and an area S2A of a first peak attributable to the metal contained in the metal layer 12 to an area S2B of a second peak attributable to the metal contained in the metal layer 12, the peaks being observed by X ray diffractometry. Hence, a surface of the metal layer 12 can be reliably coated with the metal oxide layer 13. Hence, the secondary battery separator 10, which ensures a sustained durability of the metal layer 12, can more reliably sustain its durability when applied to a nonaqueous electrolyte secondary battery.

In the secondary battery separator 10, the metal layer 12 may contain Cu, the metal oxide layer 13 may contain Cuo, the area of the peak attributable to the metal oxide may be the area of a peak attributable to a CuO plane defined by Miller indices (006), the area of the first peak attributable to the metal may be the area of a peak attributable to a Cu plane defined by Miller indices (111), and the area of the second peak attributable to the metal may be the area of a peak attributable to a Cu plane defined by Miller indices (200). Hence, when the metal layer 12 is made of a metal layer containing Cu and the metal oxide layer 13 is made of a metal oxide layer containing CuO in the secondary battery separator 10, a surface of the metal layer 12 containing Cu can be coated with the metal oxide layer 13 containing CuO. Hence, as the secondary battery separator 10 can ensure a sustained durability of the metal layer 12 also when it contains Cu as a component of the metal layer 12 and the metal oxide layer 13, it can reliably sustain the durability of a nonaqueous electrolyte secondary battery and can have the nonaqueous electrolyte secondary battery charged or discharged stably and reliably when applied to the nonaqueous electrolyte secondary battery.

It is possible to form the secondary battery separator 10 by making the metal layer 12 contain one or more selected from the group consisting of Cu, C, Sn, Al, Si, Bi, Ag, and Au. Hence, because it is easy to form the metal layer 12 and the metal layer 12 has a good conductivity, not only is it easy to produce the secondary battery separator 10, but a nonaqueous electrolyte secondary battery can be stably charged or discharged when the secondary battery separator 10 is applied to the nonaqueous electrolyte secondary battery.

It is possible to form the secondary battery separator 10 by making the metal oxide layer 13 contain an oxide of one or more components selected from the group consisting of Cu, C, Sn, Al, Si, Bi, Ag, and Au. Hence, because it is easy to form the metal oxide layer 13 and the metal oxide layer 13 can stably function as a passive state layer, not only is it easy to produce the secondary battery separator 10, but a nonaqueous electrolyte secondary battery that may be placed in a high-temperature, high-humidity, or high-temperature and high-humidity environment can be stably charged or discharged when the secondary battery separator 10 is applied to the nonaqueous electrolyte secondary battery.

As the secondary battery separator 10 has excellent durability as described above, it can be used effectively as a separator for a nonaqueous electrolyte secondary battery, and for a lithium ion secondary battery in particular. By using the secondary battery separator 10 as the separator of a nonaqueous electrolyte secondary battery, it is possible to prolong the lifetime of the nonaqueous electrolyte secondary battery because the nonaqueous electrolyte secondary battery can sustain its charging-discharging property even longer.

In the present embodiment, the metal oxide layer 13 needs only to be provided over an upper surface of the metal layer 12, which is a surface opposite to the porous base material 11 side, of the upper and lower opposite surfaces of the metal layer 12, and may also be provided over the lower surface of the metal layer 12. Another example of the configuration of the secondary battery separator 10 is illustrated in FIG. 2. As illustrated in FIG. 2, the secondary battery separator 10 may include a porous base material 11, a metal layer 12, and metal oxide layers 13A and 13B situated over both of opposite surfaces of the metal layer 12, and may include the metal oxide layer 13A, the metal layer 12, and the metal oxide layer 13B, which are laminated in this order, over an upper surface of the porous base material 11. Hence, the secondary battery separator 10 can be inhibited from development of natural oxidization not only from the surface of the metal layer 12 on the metal oxide layer 13B side but also from the surface of the porous base material 11 side. Hence, even when the secondary battery separator 10 is exposed to a high-temperature, or high-humidity, or high-temperature and high-humidity environment by being applied to a nonaqueous electrolyte secondary battery, the metal layer 12 can be inhibited from being oxidized from both of the opposite surfaces thereof on the metal oxide layer 13B side and the porous base material 11 side to the interior thereof. Hence, the metal layer 12 can sustain its function more stably and can have a better increased durability. Hence, in this case, the secondary battery separator 10 can have a better durability when applied to a nonaqueous electrolyte secondary battery.

### [Nonaqueous Electrolyte Secondary Battery]

A case of applying the secondary battery separator according to the present embodiment to a nonaqueous electrolyte secondary battery will be described. Examples of the nonaqueous electrolyte secondary battery include a lithium ion secondary battery, a nickel-hydrogen secondary battery, a nickel-cadmium secondary battery, and a polymer secondary battery. In the present embodiment, a case of the nonaqueous electrolyte secondary battery being a lithium ion secondary battery will be described.

The nonaqueous electrolyte secondary battery according to the present embodiment includes a positive electrode and a negative electrode as a pair of electrodes, and a separator. For example, the nonaqueous electrolyte secondary battery according to the present embodiment has a structure of a battery element, in which the positive electrode and the negative electrode face each other via the separator, being sealed together with a nonaqueous electrolyte within a housing (exterior material). As the separator, the secondary battery separator 10 according to the present embodiment is used. Because of using the secondary battery separator 10 according to the present embodiment as the separator, the nonaqueous electrolyte secondary battery according to the present embodiment can have excellent durability.

The positive electrode, the negative electrode, the nonaqueous electrolyte, and the housing of the nonaqueous electrolyte secondary battery according to the present embodiment will be described below.

### <Positive Electrode>

The positive electrode is not particularly limited so long as it is commonly used as a positive electrode of a nonaqueous electrolyte secondary battery. As the positive electrode, it is possible to use, for example, a positive electrode sheet having a structure in which a positive-electrode active material layer containing a positive-electrode active material and a binder (binder resin) is molded over a positive-electrode current collector.

As the positive-electrode active material, it is possible to use, for example, a material that can be doped with and de-doped with a metal ion such as a lithium ion or a sodium ion. An example of the material is a complex lithium oxide containing at least one transition metal such as V, Mn, Fe, Co, and Ni. Specific examples of the complex lithium oxide include LiCoO₂, LiNiO₂, LiMn_{1/2}Ni_{1/2}O₂, LiCo_{1/3}Mn_{1/3}Ni_{1/3}O₂, LiMn₂O₄, LiFePO₄, LiCo_{1/2}Ni_{1/2}O₂, and LiAl_{1/4}Ni_{3/4}O₂. In the present embodiment, the separator may be positioned in contact with the positive electrode and the negative electrode, because the separator has excellent oxidization resistance. Hence, for example, LiMn_{1/2}Ni_{1/2}O₂ and LiCo_{1/3}Mn_{1/3}Ni_{1/3}O₂ that can function at a high voltage of 4.2 V or higher can be favorably used as the positive-electrode active substance.

Examples of the binder include fluororesins such as polyvinylidene fluoride (PVDF), acrylic resins, and styrene/butadiene copolymers. The binder also has a function as a thickener.

The positive-electrode active material layer may further contain a conducting agent. Examples of the conducting agent include carbon materials such as natural graphite, artificial graphite, cokes, carbon black, pyrolytic carbons, carbon fibers, and fired products of organic polymer compounds. One conducting agent may be used alone or two or more conducting agents may be used in combination.

Examples of the positive-electrode current collector include conductors such as Al, Ni, Ti, and stainless steel having a thickness of from 5 μm through 20 μm. Among these, Al is more preferable because Al can be easily formed into a thin film and is low-cost.

Examples of the method for producing the positive electrode sheet include: a method of pressure-molding the positive-electrode active material, the conducting agent, and the binder over the positive-electrode current collector; and a method of preparing the positive-electrode active material, the conducting agent, and the binder in a paste form by using an appropriate organic solvent, subsequently applying the paste over the positive-electrode current collector, drying the paste, and subsequently pressurizing the resulting product to fix it on the positive-electrode current collector.

### <Negative Electrode>

The negative electrode is not particularly limited so long as it is commonly used as a negative electrode of a nonaqueous electrolyte secondary battery. As the negative electrode, it is possible to use, for example, a negative electrode sheet having a structure in which a negative-electrode active material layer containing a negative-electrode active material and a binder is molded over a negative-electrode current collector.

Examples of the negative-electrode active material include materials that can be doped and de-doped with a lithium ion, the lithium metal, and lithium alloys. Examples of materials that can be used include: carbon materials such as natural graphite, artificial graphite, cokes, carbon black, pyrolytic carbons, and carbon fibers; chalcogen compounds such as oxides and sulfides that dope and de-dope with a lithium ion at a potential lower than that of the positive electrode; metals such as Al, Pb, Sn, Bi, and Si that alloy with alkali metals; cubic-crystal intermetallic compounds (AlSb, Mg₂Si, and NiSi₂) into which alkali metals can be interstitially inserted; and lithium-nitrogen compounds (Li₃₋ₓMₓN (M: a transition metal)).

Examples of the binder include polyvinylidene fluoride-based resins, and styrene/butadiene copolymers.

The negative-electrode active material layer may further contain a conducting agent. Examples of the conducting agent include carbon materials such as acetylene black, Ketjen black, graphite powder, and extra-fine carbon fiber.

Examples of the negative-electrode current collector include Cu, Ni, and stainless steel having a thickness of from 5 μm through 20 μm. Cu is more preferable because it does not readily alloy with lithium and can be easily formed into a thin film.

Examples of the method for producing the negative electrode sheet include: a method of pressure-molding the negative-electrode active material over the negative-electrode current collector; and a method of preparing the negative-electrode active material in a paste form by using an appropriate organic solvent, subsequently applying the paste over the negative-electrode current collector, drying the paste, and subsequently pressurizing the resulting product to fix it on the negative-electrode current collector. It is preferable that the paste contains the conducting agent and the binder.

### (Nonaqueous Electrolyte)

As the nonaqueous electrolyte, for example, a nonaqueous electrolytic solution can be used.

### ((Nonaqueous Electrolytic Solution))

The nonaqueous electrolytic solution is a nonaqueous electrolytic solution commonly used in a nonaqueous electrolytic solution secondary battery, and is not particularly limited. For example, a solution obtained by dissolving a lithium salt in an organic solvent can be used.

Examples of the lithium salt include LiClO₄, LiPF₆, LiAsF₆, LiSbF₆, LiBF₄, LiCF₃SO₃, LIN (CF₃SO₂)₂, LiC(CF₃SO₂)₃, Li₂B₁₀Cl₁₀, lithium salts of lower aliphatic carboxylic acids, and LiAlCl₄. One lithium salt may be used alone or two or more lithium salts may be used in combination. Among lithium salts, at least one fluorine-containing lithium salt selected from the group consisting of LiPF₆, LiAsF₆, LiSbF₆, LiBF₄, LiCF₃SO₃, LiN(CF₃SO₂)₂, and LiC(CF₃SO₂)₃ is more preferable.

Examples of the organic solvent include: cyclic carbonates such as ethylene carbonate, propylene carbonate, fluoroethylene carbonate, difluoroethylene carbonate, and vinylene carbonate; chain carbonates such as dimethyl carbonate, diethyl carbonate, ethyl methyl carbonate, and fluorine-substituted products thereof; ethers such as 1,2-dimethoxyethane, 1,3-dimethoxypropane, and pentafluoropropyl methyl ether; and esters such as methyl formate, methyl acetate, γ-butyrolactone, and γ-valerolactone. One organic solvent may be used alone or two or more organic solvents may be used in combination. Among the organic solvents, carbonates are preferable, and mixed solvents of cyclic carbonates and chain carbonates are more preferable.

### (Housing)

The housing is a container in which the positive electrode, the separator, the negative electrode, and the nonaqueous electrolyte are contained. Examples of the housing include a metallic can, and a pack made of aluminum laminated film.

The housing may appropriately have a desirably selected shape depending on the shape of the nonaqueous electrolyte secondary battery. Examples of the shape of the nonaqueous electrolyte secondary battery include a thin plate (paper) shape, a disk (coin) shape, a cylindrical shape, and a prismatic columnar shape such as a cuboid. The housing may be formed into a desirably selected shape depending on the shape of the nonaqueous electrolyte secondary battery.

The method for producing the nonaqueous electrolyte secondary battery is not particularly limited, and a desirably selected production method may be appropriately used. For example, it is possible to obtain the nonaqueous electrolytic solution secondary battery according to the present embodiment, by positioning the positive electrode, the separator, and the negative electrode in this order to form a nonaqueous electrolytic solution secondary battery element, subsequently placing the nonaqueous electrolytic solution secondary battery element inside the housing, filling the container with the nonaqueous electrolytic solution, and subsequently tightly sealing the container under decompression.

The shape of the nonaqueous electrolyte secondary battery is not particularly limited, and may be a thin plate shape, a disk shape, a cylindrical shape, and a prismatic columnar shape such as a cuboid.

Because the nonaqueous electrolyte secondary battery according to the present embodiment uses the secondary battery separator 10 according to the present embodiment as the separator, it can be inhibited from reduction in the charging-discharging efficiency, and can sustain the charging-discharging property longer. Hence, the nonaqueous electrolyte secondary battery according to the present embodiment can prolong its service period while being inhibited from reduction in the charging-discharging property.

Since the nonaqueous electrolyte secondary battery according to the present embodiment has such a property as described above, it can be favorably used on portable electronic devices such as portable terminals, portable phones, and laptop personal computers, and electric-powered vehicles such as electric vehicles (EV), hybrid vehicles (HV), and plug-in hybrid vehicles (PHV).

### EXAMPLES

The embodiment will be more specifically described by way of Examples and Comparative Examples. The embodiment should not be construed as being limited by these Examples and Comparative Examples.

### <Production of Separator>

### Example 1

### (Formation of Metal Layer)

A porous base material (a PVDF/PE/PVDF three-layered resin porous film, having a thickness of 16 μm) was mounted on a roll-to-roll (R to R) sputter film formation apparatus. While the porous base material was taken up using a drum roll cooled to −10° C., the degree of vacuum in the atmosphere in the sputter film formation apparatus during a run without film formation was set to 1×10⁻⁵ Pa, using a gas evacuation system including a cryocoil and a turbopump. Subsequently, with the vacuum maintained, Cu was sputtered by a sputtering method, from a copper target that was previously set on an electrode of the sputter film formation apparatus, to form a Cu film, which was a metal layer having a thickness of 30 nm. Here, only argon gas was used as the process gas. The conveying speed of the porous base material was adjusted such that the thickness of the Cu film would be 30 nm.

### (Formation of Metal Oxide Layer)

Next, as the process gas, a mixed gas was supplied into the sputter film formation apparatus by mixing argon with oxygen at a flow rate of 10% with respect to argon. Then, using a copper target, CuO was sputtered by a sputtering method, to form a CuO film, which was a metal oxide layer, over the Cu film. The conveying speed of the porous base material was adjusted such that the thickness of the CuO film would be 5 nm. By the CuO film being formed over the Cu film, a separator for a nonaqueous electrolyte secondary battery was produced.

The material and thickness of the porous base material, the Cu film, and the CuO film are indicated in Table 1.

### Examples 2 and 3

Separators for nonaqueous electrolyte secondary batteries were produced in the same manner as in Example 1, except that the thickness of the metal oxide layer in Example 1 was changed to the thickness indicated in Table 1.

### Comparative Example 1

A separator for a nonaqueous electrolyte secondary battery was produced in the same manner as in Example 1, except that unlike in Example 1, no metal oxide layer was formed.

### <Durability Evaluation>

The durability of the separators for nonaqueous electrolyte secondary batteries was evaluated. The durability of the separators for nonaqueous electrolyte secondary batteries was evaluated based on the resistance value changing percentage.

### [Durability in High-Humidity Environment]

The separators for nonaqueous electrolyte secondary batteries produced in Examples and Comparative Example were used as test pieces. The test pieces were left in a high-humidity environment in which the temperature was 40° C. and the relative humidity was 92% for 7 days. Subsequently, the sheet resistances of the test pieces before and after being left in the high-humidity environment were measured using a non-contact resistance measuring instrument (NC-80MAP, obtained from NAPSON Corporation) according to an eddy current measuring method based on JIS Z 2316-1: 2014. Based on the measurement results, the values (|Rp1−Rb1|/Rb1×100(%)) of the test pieces were calculated as the sheet resistance changing percentage. Rp1 was the sheet resistance value of the test piece after being left in the high-humidity environment, and Rb1 was the sheet resistance value of the test piece before being left in the high-humidity environment. When the sheet resistance changing percentage (|Rp1−Rb1|/Rb1×100) was 20% or lower ((|Rp1−Rb1|/Rb1×100)≤20%), the test piece was evaluated as having a good durability in the high humidity. The sheet resistance changing percentage measurement results are indicated in Table 1.

### [Durability in High-Temperature Environment]

Using the separators for nonaqueous electrolyte secondary batteries produced in Examples and Comparative Example as test pieces, the same was performed as in [Durability in high humidity] except that the test pieces were left in a high-temperature environment in which the temperature was 85° C. for 7 days, to calculate the values (|Rp2−Rb2|/Rb2×100(%)) of the test pieces in the high-temperature environment as the sheet resistance changing percentage. Rp2 was the sheet resistance value of the test piece after being left in the high-temperature environment, and Rb2 was the sheet resistance value of the test piece before being left in the high-temperature environment. When the sheet resistance changing percentage (|Rp2−Rb2|/Rb2×100) was 1,000% or lower ((|Rp2−Rb2|/Rb2×100)≤1000%), the test piece was evaluated as having a good durability at the high temperature. The sheet resistance changing percentage measurement results are indicated in Table 1.

### [Durability in High-Temperature and High-Humidity Environment]

Using the separators for nonaqueous electrolyte secondary batteries produced in Examples and Comparative Example as test pieces, the same was performed as in [Durability in high humidity] except that the test pieces were left in a high-temperature and high-humidity environment in which the temperature was 85° C. and the humidity was 85° C. for 1 day, to calculate the values (|Rp3−Rb3|/Rb3×100(%)) of the test pieces in the high-temperature and high-humidity environment as the sheet resistance changing percentage. Rp3 was the sheet resistance value of the test piece after being left in the high-temperature and high-humidity environment, and Rb3 was the sheet resistance value of the test piece before being left in the high-temperature and high-humidity environment. When the sheet resistance changing percentage (|Rp3−Rb3|/Rb3×100) was 1,000% or lower ((|Rp3−Rb3|/Rb3×100)≤100%), the test piece was evaluated as having a good durability at the high temperature and in the high humidity. The sheet resistance changing percentage measurement results are indicated in Table 1.

### (Peak Area Ratio Calculation)

Of the secondary battery separators produced in Examples and Comparative Example, the secondary battery separators of Example 3 and Comparative Example 1 were subjected to XRD, to confirm diffraction peaks of CuO and Cu. X-ray diffraction patterns of the test pieces of Example 3 and Comparative Example 1 were measured using an automated multipurpose X-ray diffractometer (SmartLab, obtained from Rigaku Corporation). As a result, a diffraction peak that was attributable to a copper oxide (CuO) plane defined by Miller indices (006) and that centered at 42.7°, a diffraction peak that was attributable to a copper (Cu) plane defined by Miller indices (111) and that centered at 43.3°, and a diffraction peak that was attributable to a Cu plane defined by Miller indices (200) and that centered at 50.4° were observed. The diffraction peaks were fitted by Gaussian fitting, to calculate the peak areas of the respective diffraction peaks. The peak area ratio ((CuO(006)+Cu(111))/Cu(200)) of the sum of the peak area of the diffraction peak that was attributable to the CuO plane defined by Miller indices (006) and that centered at 42.7° and the peak area of the diffraction peak that was attributable to the Cu plane defined by Miller indices (111) and that centered at 43.3° to the peak area of the diffraction peak that was attributable to the Cu plane defined by Miller indices (200) and that centered at 50.4° was calculated. For calculation of the peak area ratio, OriginLab Corporation's software (OriginPro 2021, obtained from LightStone Corp.) was used. As Comparative Example 1 was free of a metal oxide layer, the peak area ratio was not ((CuO(006)+Cu(111))/Cu(200)), but was Cu(111)/Cu(200).

In order to evaluate the diffraction peak that was attributable to the CuO plane defined by Miller indices (006) and that centered at 42.7° and the diffraction peak that was attributable to the Cu plane defined by Miller indices (111) and that was around 43.3°, the bottoms of diffraction peaks observed around 41.5° and around 45° were joined by a straight line, to find a baseline.

Regarding Comparative Example 1, Gaussian fitting was based on one diffraction peak. The result was determined as the diffraction peak attributable to the Cu plane defined by Miller indices (111).

Regarding Example 3, using the parameters of the fitting function of Comparative Example 1 as is, one diffraction peak was determined as the diffraction peak attributable to the Cu plane defined by Miller indices (111).

Differences between the measurement data and another Gauss function were fitted. The result was determined as the diffraction peak that was attributable to the CuO plane defined by Miller indices (006) and that centered at 42.7°.

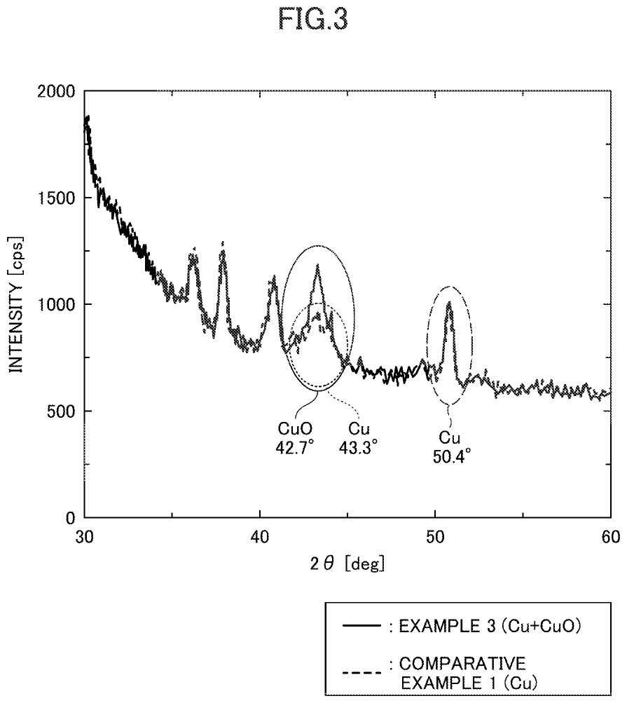

The peak area ratio (Cu(111)/Cu(200)) of the area of the peak attributable to the Cu plane defined by Miller indices (111) to the area of the peak attributable to the Cu plane defined by Miller indices (200) was calculated to be approximately 1.37. This peak area ratio was the peak area ratio of Comparative Example 1. The peak area ratio ((CuO(006)+Cu(111))/Cu(200)) of a value obtained by adding the area of the peak attributable to the CuO plane defined by Miller indices (006) to the area of the peak attributable to the Cu plane defined by Miller indices (111) to the area of the peak attributable to the Cu plane defined by Miller indices (200) was calculated to be approximately 3.13. This peak area ratio was the peak area ratio of Example 3. The whole of this increment was considered attributable to CuO contained in the metal oxide layer. The XRD measurement results are indicated in FIG. 3 and Table 2.

TABLE 1

| | | | | | | | Durability | | |
|---|---|---|---|---|---|---|---|---|---|
| | | | | | | | Resistance changing | | |
| | | | | | | | percentage | | |
| | | | | | | | | | High temp., |
| | | | | | | | High HUM | | high HUM |
| | | | | | Metal oxide | | environ. | High temp. | environ. |
| | Porous base material | | Metal layer | | layer | | (temp.: 40° C., | environ. | (temp.: 85° C., |
| | | Thickness | | Thickness | | Thickness | HUM: 92%, | (temp.: 85° C. | HUM: 85%, |
| | Material | [nm] | Material | [nm] | Material | [nm] | left for 7 d) | left for 7 d) | left for 1 d) |
| Ex. 1 | PVDF/PE/PVDF | 16 | Cu | 30 | CuO | 5 | 4 | 370 | 60 |
| Ex. 2 | PVDF/PE/PVDF | 16 | Cu | 30 | CuO | 10 | 10 | 250 | 42 |
| Ex. 3 | PVDF/PE/PVDF | 16 | Cu | 30 | CuO | 30 | −5 | 130 | 15 |
| Comp. | PVDF/PE/PVDF | 16 | Cu | 30 | None | 0 | 25 | 1,100 | >1,000 |
| Ex. 1 | | | | | | | | | |

TABLE 2

| | | | | Peak area ratio |
|---|---|---|---|---|
| | | | Peak | ((CuO(006) + |
| | Type | Attribution | area | Cu(111))/Cu(200)) |
| Ex. 3 | Metal oxide layer | CuO(006) | 282.4 | 3.13 |
| | Metal layer | Cu(111) | 230.6 | |
| | | Cu(200) | 163.7 | |
| Comp. | Metal layer | Cu(111) | 230.6 | 1.37 |
| Ex. 1 | | Cu(200) | 168.6 | |

It is seen from Table 1 that in Examples 1 to 3, the absolute values of the resistance changing percentages in the high-humidity environment were 10% or lower, the absolute values of the resistance changing percentages in the high-humidity environment were 370% or lower, and the absolute values of the resistance changing percentages in the high-temperature and high-humidity environment were 60% or lower. On the other hand, in Comparative Example 1, the absolute value of the resistance changing percentage in the high-humidity environment was 25%, the absolute value of the resistance changing percentage in the high-temperature environment was 1, 100%, and the absolute value of the resistance changing percentage in the high-temperature and high-humidity environment was by far higher than 100%.

It is seen from Table 2 that in Example 3, the peak area ratio ((CuO(006)+Cu(111))/Cu(200)) calculated based on XRD of the secondary battery separator was 3.13. On the other hand, in Comparative Example 1, the peak area ratio (Cu(111)/Cu(200)) calculated based on XRD of the secondary battery separator was 1.37. Hence, it was confirmed that without the need to form a CuO film over the surface of the Cu film, the surface of Cu underwent oxidization and became CuO. However, it could be considered that CuO that was produced from the surface of Cu undergoing oxidization had a small peak area and had a low peak area ratio ((CuO(006)+Cu(111))/Cu(200)). As compared with this, it could be concluded that the peak area ratio ((CuO(006)+Cu(111))/Cu(200)) became a large value of 3.13 by the CuO film being formed over the surface of the Cu film. In Examples 1 and 2, diffraction patterns attributable to copper oxide were not confirmed by XRD, so no peak area ratios ((CuO(006)+Cu(111))/Cu(200)) were calculated. However, since the production process was the same except the thickness of the CuO film, it could be said that the area of the CuO-attributable peak would be measured to be a large value, and the peak area ratio ((CuO(006)+Cu(111))/Cu(200)) would be 1.40 or greater.

Hence, in the secondary battery separators of Examples 1 to 3 that were provided with metal oxide layers of from 5 nm through 30 nm unlike the secondary battery separator of Comparative Example 1, the metal oxide layers could function as passive state layers and inhibit development of oxidization from the surface of the metal layer. Hence, it could be said that they could increase durability when applied to lithium ion secondary batteries. Hence, it could be said that the serviceable period of lithium ion secondary batteries employing the secondary battery separators of Examples 1 to 3 could be prolonged with inhibition of reduction in the charging-discharging property.

Hence, the embodiment has been described as above. The embodiment described above is presented as an example, and the present invention is not limited by the embodiments described above. The embodiment described above can be carried out in other various modes, and various combinations, omissions, replacements, and modifications are applicable within the scope of the spirit of the invention. The embodiment and modifications thereof are included in the scope and spirit of the invention, and are also included in the scope of the invention described in the claims and equivalents thereof.

Aspects of the embodiment of the present invention are, for example, as follows.

<1> A separator for a nonaqueous electrolyte secondary battery, the separator including:
a porous base material;
a metal layer situated over either or both of opposite surfaces of the porous base material; and
a metal oxide layer situated either over one of opposite surfaces of the metal layer or over both of the opposite surfaces of the metal layer, the one being a surface opposite to a surface of the metal layer on a side of the porous base material.

<2> The separator for a nonaqueous electrolyte secondary battery according to <1>,
wherein a thickness of the metal oxide layer is from 3 nm through 100 nm.

<3> The separator for a nonaqueous electrolyte secondary battery according to <1> or <2>,
wherein a ratio of a sum of an area of a peak attributable to a metal oxide contained in the metal oxide layer and an area of a first peak attributable to a metal contained in the metal layer to an area of a second peak attributable to the metal contained in the metal layer is 1.40 or greater, the peaks being observed by X-ray diffractometry.

<4> The separator for a nonaqueous electrolyte secondary battery according to <3>,
wherein the metal layer contains Cu and the metal oxide layer contains CuO,
the area of the peak attributable to the metal oxide is an area of a peak attributable to a CuO plane defined by Miller indices (006),
the area of the first peak attributable to the metal is an area of a peak attributable to a Cu plane defined by Miller indices (111), and
the area of the second peak attributable to the metal is an area of a peak attributable to a Cu plane defined by Miller indices (200).

<5> The separator for a nonaqueous electrolyte secondary battery according to any one of <1> to <4>,
wherein the metal layer contains one or more components selected from the group consisting of Cu, C, Sn, Al, Si, Bi, Ag, and Au.

<6> The separator for a nonaqueous electrolyte secondary battery according to any one of <1> to <5>,
wherein the metal oxide layer contains an oxide of one or more components selected from the group consisting of Cu, C, Sn, Al, Si, Bi, Ag, and Au.

<7> A nonaqueous electrolyte secondary battery, including:
a pair of electrodes; and
a separator situated between the pair of electrodes,
wherein the separator is the separator for a nonaqueous electrolyte secondary battery of any one of <1> to <6>.

The present application is based on and claims priority to Japanese Patent Application No. 2021-106550, filed Jun. 28, 2021. The entire content of Japanese Patent Application No. 2021-106550 is incorporated herein by reference.

### REFERENCE SIGNS LIST

10 separator for a nonaqueous electrolyte secondary battery (secondary battery separator)
11 porous base material
12 metal layer
13, 13A, 13B metal oxide layer

1. A separator for a nonaqueous electrolyte secondary battery, the separator comprising:
a porous base material;
a metal layer situated over either or both of opposite surfaces of the porous base material; and
a metal oxide layer situated either over one of opposite surfaces of the metal layer or over both of the opposite surfaces of the metal layer, the one being a surface opposite to a surface of the metal layer on a side of the porous base material.

2. The separator for a nonaqueous electrolyte secondary battery according to claim 1,
wherein a thickness of the metal oxide layer is from 3 nm through 100 nm.

3. The separator for a nonaqueous electrolyte secondary battery according to claim 1,
wherein a ratio of a sum of an area of a peak attributable to a metal oxide contained in the metal oxide layer and an area of a first peak attributable to a metal contained in the metal layer to an area of a second peak attributable to the metal contained in the metal layer is 1.40 or greater, the peaks being observed by X-ray diffractometry.

4. The separator for a nonaqueous electrolyte secondary battery according to claim 3,
wherein the metal layer contains Cu and the metal oxide layer contains CuO,
the area of the peak attributable to the metal oxide is an area of a peak attributable to a CuO plane defined by Miller indices (006),
the area of the first peak attributable to the metal is an area of a peak attributable to a Cu plane defined by Miller indices (111), and
the area of the second peak attributable to the metal is an area of a peak attributable to a Cu plane defined by Miller indices (200).

5. The separator for a nonaqueous electrolyte secondary battery according to claim 1,
wherein the metal layer contains one or more components selected from the group consisting of Cu, C, Sn, Al, Si, Bi, Ag, and Au.

6. The separator for a nonaqueous electrolyte secondary battery according to claim 1,
wherein the metal oxide layer contains an oxide of one or more components selected from the group consisting of Cu, C, Sn, Al, Si, Bi, Ag, and Au.

7. A nonaqueous electrolyte secondary battery, comprising:
a pair of electrodes; and
a separator situated between the pair of electrodes,
wherein the separator is the separator for a nonaqueous electrolyte secondary battery of claim 1.
